(19) United States
(12) Patent Application Publication
(10) Pub. No.: US 2022/0348484 A1
(43) Pub. Date: Nov. 3, 2022

(54) WATER TREATMENT DEVICE AND SYSTEM USING HYDROXYL RADICALS AND METHOD OF USING SAME

(71) Applicant: West Country Pump And Filtration Ltd., Red Deer County (CA)

(72) Inventors: Sonny Joe CHRISTENSEN, Okotoks (CA); Nickolaus Charles SZTYM, Rocky Mountain House (CA)

(21) Appl. No.: 17/243,241

(22) Filed: Apr. 28, 2021

(51) Int. Cl. C02F 1/72; C02F 1/00; C02F 1/32

(52) U.S. Cl. CPC C02F 1/72; C02F 1/008; C02F 1/325; C02F 1/001; C02F 2209/005; C02F 2303/04; C02F 2209/03; C02F 2209/42; C02F 2301/046; C02F 2305/023; C02F 2201/005; C02F 2201/322

(57) ABSTRACT

Water treatment and purification system as disclosed herein relates to a PLC controlled system utilizing a hydroxyl radical generation unit and system to treat polluted water. The system uses a hydroxyl-based advanced oxidation based on natural processes that keeps our atmosphere clean and breathable. This technology creates its own high concentration of hydroxyls that are put through a venturi system into the water to be purified to eliminate unwanted organic compounds such as hydrogen sulfide, pathogens, chloride resistant parasites, and harmful bacteria. The system can also reduce inorganic contaminants including iron and manganese.

### FIELD OF THE INVENTION

The present invention relates generally to the field of water purification, specifically to a continuous process that purifies water, more specifically to device that continuously purifies water using hydroxyl radicals.

### BACKGROUND

U.S. Pat. No. 7,285,223 (Martin)—discloses enhanced air and water purification using continuous breakpoint halogenation with free oxygen radicals. The method comprises the steps of irradiating a liquid substantially free of hydroxyl free radical scavengers with ultraviolet radiation to generate hydroxyl free radical species. The water quality of the water system is monitored, a halogen species is added to the water system, and a hydroxyl free radical species is adding to the water system, to maintain a predetermined water quality.

U.S. Pub. No. 2021/032,142 (Ramsey)—discloses a water treatment system that includes a water passage, a magnet and a hydroxyl radical generator. Water flows through the water passage and the magnet is adjacent to the water passage and produces a magnetic field in the water passage. The hydroxyl radical generator generates hydroxyl radicals in the water in the water passage. The hydroxyl radical generator includes an ozone system and a UV source. The ozone system includes an oxygen concentrator, an ozone generator and a venturi. The ozone generator generates ozone and connects to the venturi which connects to the inlet of the water passage. Water flowing through the venturi draws ozone into the water. The UV source includes three one-inch diameter UVC lamps that are each forty inches long. The UVC lamps are mounted on the water passage. The UVC lamps irradiate the ozonated water in the water passage to generate hydroxyl radicals.

CA App. No. 2,988,574 (Kim)—discloses a nanobubble-and-hydroxyl-radical generator and a system for processing polluted water. The invention provides a nano-bubble-and-hydroxyl-radical generator that can generate nano bubbles and hydroxyl radical by refining and mixing air and fluid and increase the dissolved rate of the air or ozone in the fluid and system for processing polluted water without using chemicals. The nano-bubble-and-hydroxyl-radical generator is composed of a pump that a fluid can flow in and flow out; and a driving motor connected to one side of the above pump. The nano-bubble-and-hydroxyl-radical generator improves the water quality by increasing the dissolved rate by generating nano bubbles and hydroxyl radical refining and mixing gases such as air, oxygen and ozone and supplying to wetlands, hazards or other reservoirs in golf courses, sewage treatment plants, fish tanks or fish farms.

U.S. Pat. No. 7,319,921 (Underwood)—discloses a water treatment control system. The invention relates to a control and communication system for controlling and monitoring components within a water filter system. The control logic of the control subsystem is a programmable logic controller that provides the necessary processors to transmit and receive data.

CN App. No. 103034211 (Weili)—discloses a wastewater treatment process monitoring system based on a wireless network. A monitoring slave station adopts the programmable logic controller, and comprises a digital quantity input module, digital output module, analog input module, analog output module and CPU module, to connect between each module by hardware configuration. The monitoring slave station is an Ethernet protocol with the MPI protocol conversion, be connected to the secondary radio station transmission system.

U.S. application Ser. No. 10/259,729 (Buschmann)—discloses systems and method of wastewater treatment utilizing reactive oxygen species and applications thereof. The method may include separating contaminants from impaired water and contacting impaired water with a peracetate oxidant solution. The water phase has had at least a majority of hydrocarbons (e.g., oil) and/or at least a majority of solids removed after interaction with reactive oxygen species. Mixers can provide high shear or low shear mixing conditions and include in-line static mixers, baffle mixers, orifice plate mixers, impeller mixers, venturi mixers, tank mixer, mixing in a pump head by an impeller, turbulent flow mixing in a progressing cavity pump head or turbulent flow mixing in a conduit such as a pipe, tube or hose.

CN Pat. No. 2908478 (Chunlin)—discloses sewage disinfection, detoxification and purification device by hydroxyl radical. The process is achieved by introducing a kind of hydroxyl radical free radical to the wastewater disinfection refining plant that detoxifies, comprise housing, ozone generating machine, ozone proof oil-free air compressor, and ultraviolet lamp. The ultraviolet ray generated hydroxyl radical free radicals can kill various objectionable impurities such as bacterium and virus in the sewage.

U.S. Pat. No. 8,313,619 (Joshi)—discloses enhanced generation of hydroxyl radicals. The invention provides a process for enhancing the generation of hydroxyl radicals in aqueous mixtures containing hydrogen peroxide, which process comprises supplying oxygen and magnesium oxide, as a catalyst, to the mixture and irradiating it with UV light. The process can be used, for example, for processing ballast water, industrial waste waters, and municipal waste waters.

CA App. No. 2,573,212 (Nightingale)—discloses an oxidation filtration system for cleaning groundwater, the system having an aeration tower and a filtration tank. Within the filtration tank is an upper chamber and a lower chamber. Contained within the lower chamber is a plurality of Styrofoam™ filter media. Separating the upper chamber from lower chamber is a filter media mask which keeps the filter media from entering into the upper chamber. As the water passes through the filter media, the dissolved solvents fallout of the groundwater and attach themselves to the Styrofoam™ media. An automated back flushing and clarifying process is also provided using a back flush port and a clarification port, a higher level water sensor in the aeration tower and a programmable logic controller.

All documents cited herein are incorporated by reference.

None of the above cited documents, alone or in combination satisfy the need for a device that can safely and rapidly purify contaminated water using a process that does not introduce potentially harmful chemicals into the water that has been purified.

### BRIEF SUMMARY

It is an object of the invention to provide a water treatment device and system using hydroxyl radicals and method of using same.

In accordance with an aspect of the invention there is provided a water purification system, said system comprising: a water circulation system comprising: one or more valves; one or more pumps; and a water entry point in fluid connection with a water exit point; a hydroxyl radical generating system comprising a UV light; a humid air circulating system comprising: a humid air entry point; a fan circulating humid air through said hydroxyl radical generating system; and a means of injecting hydroxyl radical enriched humid air into said water circulation system; and a programmable logic controller.

In accordance with another aspect of the invention there is provided the water purification system as described, additionally comprising a sensor in said water circulation system, said sensor monitoring purity of water in said water circulation system, said sensor being controlled by said programmable logic controller, wherein when a specific level of purity of said water in said water circulation system is measured, said programmable logic controller activates one or more of said one or more valves and one or more of said one or more pumps to divert water in said water circulation system to said water exit point.

In accordance with an additional aspect of the invention there is provided a method of purifying water, said method comprising the steps: pumping water to be purified into a water circulation system comprising: one or more valves; one or more pumps; and a water entry point in fluid connection with a water exit point; generating hydroxyl radicals in a hydroxyl radical generating system comprising a UV light; circulating humid air around a humid air circulating system comprising: a humid air entry point; a fan circulating humid air through said hydroxyl radical generating system; and a means of injecting hydroxyl radical enriched humid air into said water circulation system; and controlling flow of water around said water circulation system and flow of humid air through said hydroxyl radical generating system by use of a programmable logic controller.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

FIG. 1 illustrates a perspective view of an aspect of the light box in accordance with one embodiment of the invention.

FIG. 2 illustrates a diagram of the system in accordance with one embodiment of the invention.

FIG. 3 illustrates a flow diagram of the subject matter in accordance with one embodiment of the invention.

### DETAILED DESCRIPTION

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

Water treatment and purification system as disclosed herein relates to a PLC controlled system utilizing a hydroxyl radical generation unit and system to treat polluted water. The system uses a hydroxyl-based advanced oxidation based on natural processes that keeps our atmosphere clean and breathable. This technology creates its own high concentration of hydroxyls that are put through a venturi system into the water to be purified to eliminate unwanted organic compounds such as hydrogen sulfide, pathogens, chloride resistant parasites, and harmful bacteria. The system can also reduce iron and manganese contaminants.

With residual sanitation, this hydroxyl-based advanced oxidation process is proven to eliminate or minimize the need for chlorine or hydrogen peroxide from existing water treatment systems in the same way that hydroxyl radicals purify the earth's atmosphere. Hydroxyl radicals are the key to cleansing water without the use of aggressive harsh chemicals.

The hydroxyl radical, OH, is the neutral form of the hydroxide ion (OH—). Hydroxyl radicals are highly reactive (easily becoming hydroxyl groups) and consequently short-lived; however, they form an important part of radical chemistry. The hydroxyl radical is often referred to as the “detergent” of the troposphere because it reacts with many pollutants, decomposing them through “cracking”, often acting as the first step to their removal. The system as described herein related to the use of OH radicals, that oxidize organic compounds. Hydroxyl radicals play a key role in the oxidative destruction of organic pollutants using a series of methodologies collectively known as Advanced Oxidation Processes (AOPs). The destruction of pollutants in AOPs is based on the non-selective reaction of hydroxyl radicals on organic compounds. These radicals are highly effective against a series of pollutants including pesticides, pharmaceutical compounds, dyes, etc. The hydroxyl radical can damage virtually all types of macromolecules: carbohydrates, nucleic acids (mutations), lipids (lipid peroxidation), and amino acids (e.g. conversion of phenylalanine to m-tyrosine and o-tyrosine). The hydroxyl radical has a very short in vivo half-life and a high reactivity. This makes it a very dangerous compound to any organism. Unlike superoxide, which can be detoxified by superoxide dismutase, hydroxyl radicals cannot be eliminated by an enzymatic reaction.

In the currently described system, the hydroxyl radicals are produced using ultraviolet irradiation. Typically, the UV irradiation used is short wavelength ultraviolet (ultraviolet C or UV-C) light. The hydroxyl radicals that are produced then kill or inactivate organic material and microorganisms such as bacteria, viruses, molds, and other pathogens. This is achieved by destroying nucleic acids and disrupting the DNA of the microorganism, leaving them unable to perform vital cellular functions. Subsequent filtration of the purified water removed the inactivated organic matter.

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

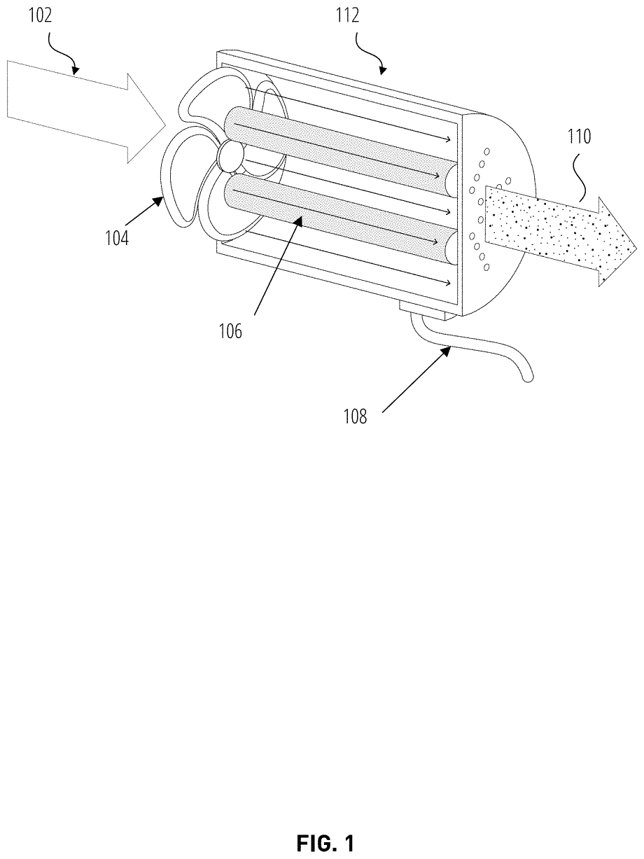

FIG. 1 illustrates a hydroxyl radical generating element in accordance with an embodiment of the invention.

Humid air 102 is blown into the light chamber 112 using a fan 104. The humid air 102 passes over a UV light bulb 106 which produces hydroxyl radicals that exit the light chamber 112 via the hydroxyl radical exit 110. The UV light bulb 106 and fan 104 are powered by an electrical supply 108.

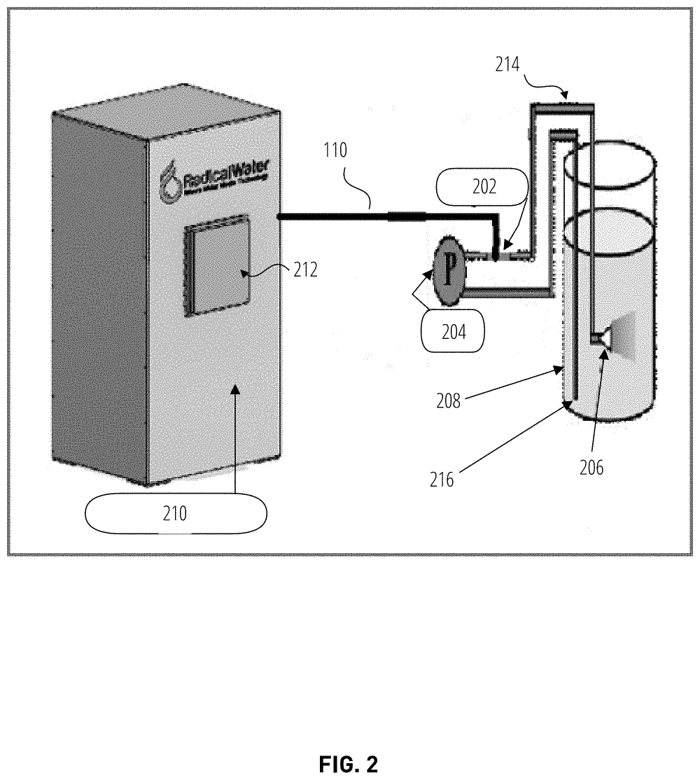

FIG. 2 illustrates a hydroxyl radical generating unit in accordance with an embodiment of the invention.

This figure shows the hydroxyl generating unit 210, that comprises the light chamber 112 and associated elements as illustrated in FIG. 1. The humid air containing hydroxyl radicals exits the hydroxyl generating unit 210 via the hydroxyl radical exit 110.

A water circulatory system 214 can be seen circulating water to be purified. Water is retained in a retention tank 208 having a return water pipe 216 driven by a pump 204. An injector 202 dispenses the humid air containing hydroxyl radicals into the water circulatory system 214. The hydroxyl enriched water then enters the retention tank 208 via a spray nozzle 206. In this particular embodiment, the spray nozzle 206 is positioned below the level of water in the retention tank 208. A programmable logic controller (PLC) 212 monitors and controls the flow rate of the water, the rate of dosing in of the hydroxyl radicals and the purity of the circulating water.

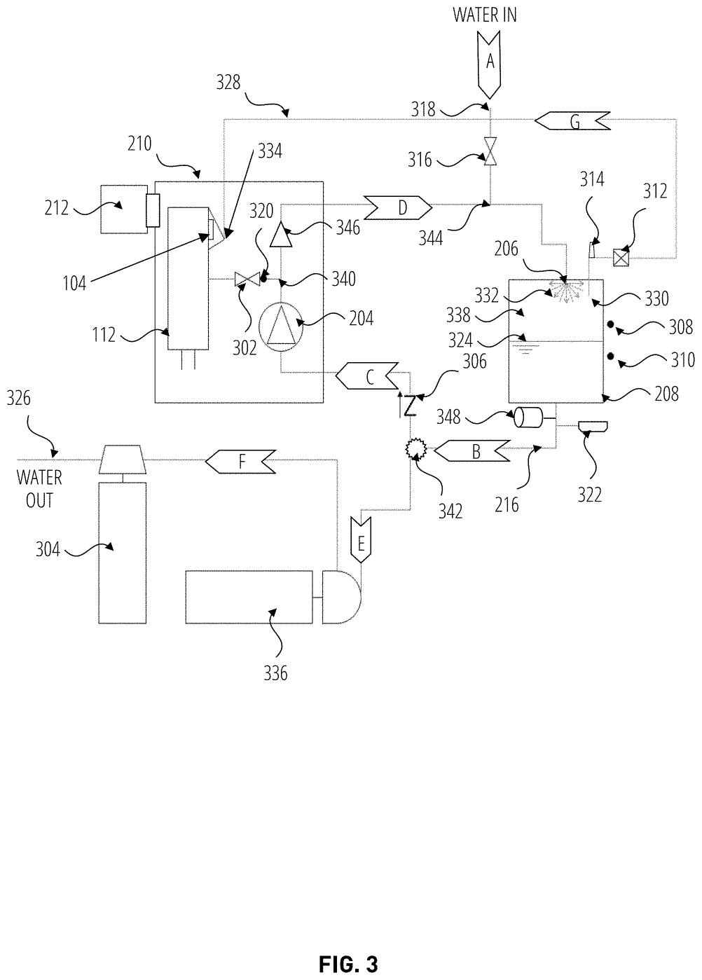

FIG. 3 illustrates the process of the hydroxyl radical generation and dosing system in accordance with an embodiment of the invention.

Water to be purified enters the system in the direction shown by Arrow A as the water supply 318. A solenoid 316, controlled by the programmable logic controller (PLC) 212, controls the rate of flow of the water supply 318. The water flows around the water circulatory system 214 in the direction as indicated by Arrows B, C and D. After entering the water circulatory system 214, the water to be purified enters the retention tank 208 via a spray nozzle 206. The spray nozzle 206 may be positioned to spray or mist the water into the head space 338 above the water level 324 in the retention tank 208, as shown in FIG. 3. In an alternative embodiment of the invention, as shown in FIG. 2, the spray nozzle 206 is positioned below the water level 324 to dose the hydroxyl radicals directly into the water in the retention tank 208.

A second pressure transducer 322, operated by the programmable logic controller (PLC) 212, reads the bottom pressure of the water tank. The operator of the system scales this reading in the programmable logic controller (PLC) 212 to ensure the tank does not run out of water. Also, the high-level alarm in the tank is programmed. By the weight of the operator can tell the lowest level of the water. The above combination to second pressure transducer 322 and programmable logic controller (PLC) 212 controls the flow of water out of the from the retention tank 208 via the return water pipe 216 in the direction indicated by Arrow B. When the check valve 306, which is controlled by the programmable logic controller (PLC) 212, is open, the water in the water circulatory system 214 continues to travel in the direction as indicated by Arrow C. The pump 204 circulates the water in the water circulatory system 214 past the entry point for hydroxyl radical 340 enriched humid air. The water in the water circulatory system 214, which is now enriched with hydroxyl radicals, continues in the direction as indicated by the Arrow D, past the entry point for the water supply 344, and into the retention tank 208 via the spray nozzle 206.

Humid air 102 is withdrawn from the enriched hydroxyl atmosphere 332 in the head space 338 of the retention tank 208 at the humid air inlet 330. This is achieved via a first pressure transducer 314 and an air purge valve 312. The humid air return pipe 328, travelling in the direction as indicated by Arrow G, delivers the hydroxyl enriched humid into the light chamber 112. The light chamber 112, as shown in FIG. 1, comprises the UV light bulb 106 (not shown), via the fan 104. Additional hydroxyl radicals are formed in the humid air by UV rays from the UV light bulb 106. A mechanically operated valve (MOV) 302 controls the dosing in of the hydroxyl radical enriched humid air into the water circulatory system 214 at the entry point for hydroxyl radical 340. Typically, this is achieved via a venturi 320 configuration, the hydroxyl radical enriched humid air being introduced into the vacuum in the space exiting the venturi 320. The flow switch 346 senses the operation of the pump 204 and then opens the mechanically operated valve (MOV) 302.

Water will continue to flow around the water circulatory system 214 until the water purity sensor 342 in the return water pipe 216 indicates that the water has been purified to an acceptable level. At this time, the programmable logic controller (PLC) 212 will close the check valve 306, and the purified water will flow in the direction as indicated by Arrow E. A booster pump 336 drives the purified water through the filter 304 and out of the system via the water exit 326. There is also a manual adjusted flow gauge of the front of the machine that the hydroxyl enriched hydroxyl atmosphere 332 flows though before going into the injector, which measures in liters per/min.

The level of water in the retention tank 208 is optimally maintained at approximately 50% capacity to provide an enriched hydroxyl atmosphere in top half of the tank. This is achieved via a high-level sensor 308 and a low-level sensor 310 sending signals to the programmable logic controller (PLC) 212, that in turn regulates water entering the water circulatory system 214 via the water supply 318.

The entire system is controlled by a programmable logic controller (PLC) 212 that monitors each and every aspect of the system. It provides a means of controlling and regulating the length of treatment time, level of the retention tank 208, pressure in the tank and detects when there is discharge flow from the booster pump 336. the properties of the hydroxyl generator to predicted amount of OH produced by the device, based on the output of the ultraviolet lamp and together with an estimation of the water concentration in the humid air 102 passing through the light chamber 112.

One or more other sensors may be present in the water circulatory system 214 to check the water quality. In some embodiments of the invention, an ORP meter 348 is installed to track the oxidation level in the tank. This ORP meter 348 is typically attached at the bottom of the tank beside the second pressure transducers 322. An ORP meter 348 is not installed on all water circulatory systems 214.

The programmable logic controller (PLC) 212 of the present invention can comprise a microprocessor, such as, but not limited to, a PC-based system, a distributed control system, and a PLC, or combinations thereof. The control system, as known in the art can have program logic code supervising any of the monitoring, processing and regulating sub-functions of the control system. Further, the control system can be configured in to be under feedback, feedforward or open loop control with or without any of proportional, derivative or integral hierarchy gains. Further, the control systems can have adaptive algorithms that based on, for example, artificial intelligence or neural network systems, that can adjust and learn based on use and loading demand functions, wear of equipment, such as loss of ultraviolet intensity, or even loss or failure of subsystems.

Water can be diverted out of the system at any time, as it is just a standard check valve in the line. An operator skilled in the field will know how to use flow rates to determine the number of pumps and injectors needed to meet the demand of the system.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A water purification system, said system comprising:
a water circulation system comprising: one or more valves; one or more pumps; and a water entry point in fluid connection with a water exit point;
a hydroxyl radical generating system comprising a UV light;
a humid air circulating system comprising: a humid air entry point; a fan circulating humid air through said hydroxyl radical generating system; and a means of injecting hydroxyl radical enriched humid air into said water circulation system; and
a programmable logic controller.

2. The water purification system of claim 1, wherein said water circulation system additionally comprises a water retention tank.

3. The water purification system of claim 2, wherein said water retention tank has one or more high level sensors and one or more low level sensors operably connected to said programmable logic controller, to control level of water in said tank.

4. The water purification system of claim 3, wherein said one or more high level sensors and one or more low level sensors are positioned and controlled to maintain said water retention tank at approximately 50% capacity.

5. The water purification system of claim 3, wherein water enters said retention tank via a spray nozzle.

6. The water purification system of claim 5, wherein said spray nozzle is positioned below the level of water in said tank.

7. The water purification system of claim 5, wherein said spray nozzle is positioned above the level of water in said tank.

8. The water purification system of claim 1, wherein said water circulation system additionally comprised a pressure transducer.

9. The water purification system of claim 3, wherein said humid air entry point is situated in said water retention tank above said level of water in said tank.

10. The water purification system of claim 1, wherein said means of injecting hydroxyl radical enriched humid air into said water circulation system comprises a venturi.

11. The water purification system of claim 10, wherein said humid air circulating system additionally comprises a mechanically operated valve.

12. The water purification system of claim 11, wherein said venturi is situated downstream of said mechanically operated valve.

13. The water purification system of claim 1, additionally comprising a sensor in said water circulation system, said sensor monitoring purity of water in said water circulation system, said sensor being controlled by said programmable logic controller, wherein when a specific level of purity of said water in said water circulation system is measured, said programmable logic controller activates one or more of said one or more valves and one or more of said one or more pumps to divert water in said water circulation system to said water exit point.

14. The water purification system of claim 1, additionally comprising a booster pump situated at said water exit point.

15. The water purification system of claim 1, additionally comprising a filter situated at said water exit point.

16. A method of purifying water, said method comprising the steps:
pumping water to be purified into a water circulation system comprising: one or more valves; one or more pumps; and a water entry point in fluid connection with a water exit point;
generating hydroxyl radicals in a hydroxyl radical generating system comprising a UV light;
circulating humid air around a humid air circulating system comprising: a humid air entry point; a fan circulating humid air through said hydroxyl radical generating system; and a means of injecting hydroxyl radical enriched humid air into said water circulation system; and
controlling flow of water around said water circulation system and flow of humid air through said hydroxyl radical generating system by use of a programmable logic controller.

17. The method of claim 16, comprising programming said programmable logic controller to monitor purity of water at one or more sensors in said water circulation system, wherein when an acceptable level of purity is achieved said programmable logic controller activates one or more of said one or more valves and one or more of said one or more pumps to divert water in said water circulation system to said water exit point.

18. The method of claim 16, wherein said water circulatory system additionally comprises a water retention tank and said method comprising the additional step of spraying said water to be purified into a head space above level of water in said retention tank.

19. The method of claim 18, comprising withdrawing humid air from said humid air entry point that is situated in said head space above level of water in said retention tank.

20. The method of claim 16, comprises injecting said hydroxyl radical enriched humid air into said water circulation system at a venturi.
